(19) United States
(12) Patent Application Publication
(10) Pub. No.: US 2026/0237141 A1
(43) Pub. Date: Aug. 13, 2026

(54) 3-DIMENSIONAL IMAGE PROCESSING SYSTEM, 3-DIMENSIONAL IMAGE GENERATING APPARATUS, IMAGE DISPLAY APPARATUS, AND STORAGE MEDIUM

(71) Applicant: CANON KABUSHIKI KAISHA, Tokyo (JP)

(72) Inventor: Tetsuya HATA, Kanagawa (JP)

(21) Appl. No.: 19/455,908

(22) Filed: Jan. 22, 2026

(30) Foreign Application Priority Data
Feb. 10, 2025 (JP) 2025-020363

(51) Int. Cl. G06T 15/00; G06T 17/00

(52) U.S. Cl. CPC G06T 15/00; G06T 17/00

(57) ABSTRACT

A 3-dimensional image processing system has a 3-dimensional image generating apparatus that generates a 3-dimensional image of a subject based on a plurality of images; determines a reference image that will become a reference for a display format for when the 3-dimensional image is displayed on an external image display apparatus; and transmits the 3-dimensional image, to which information relating to the reference image has been added, to the image display apparatus; and an image display apparatus that receives the 3-dimensional image to which the information relating to the reference image has been added, and displays the 3-dimensional image in a display format based on the information relating to the reference image.

### BACKGROUND

### Field

The present disclosure relates to a 3-dimensional image processing system, a 3-dimensional image generating apparatus, an image display apparatus, a storage medium, and the like.

### Description of the Related Art

Conventionally, a technology is known that is referred to as photogrammetry, which generates 3D model data of a subject based on captured images in which the subject has been image captured from a plurality of different viewpoints. By rendering the 3D model data that has been generated by photogrammetry based on a virtual viewpoint that has been set, it becomes possible to generate and display a 3D model image that is an image of the subject as seen from the viewpoint that has been set.

For example, Japanese Unexamined Patent Application, First Publication No. 2020-102687 discloses an information processing apparatus that is able to generate and display a virtual viewpoint image based on captured images that have been image captured from a plurality of different directions, and also change the virtual viewpoint position using a user operation when displaying the virtual viewpoint image.

However, in the prior art technology, in order to set the virtual viewpoint when rendering the 3D model image to the position that the user intends, it is necessary for the user to perform a setting operation for the position and direction of the virtual viewpoint at the time of the rendering, and there is the problem that this is labor-intensive.

### SUMMARY

A 3-dimensional image processing system according to an embodiment of the present disclosure comprises a 3-dimensional image generating apparatus configured to generate a 3-dimensional image of a subject based on a plurality of images; determine a reference image that will become a reference for a display format when displaying the 3-dimensional image on an external image display apparatus; and transmit the 3-dimensional image, to which information relating to the reference image has been added, to the display apparatus; and the display apparatus, which is configured to receive the 3-dimensional image to which information relating to the reference image has been added, and display the 3-dimensional image in a display format based on the information relating to the reference image.

Further features of the present disclosure will become apparent from the following description of embodiments with reference to the attached drawings.

### BRIEF DESCRIPTION OF THE DRAWINGS

FIG. 1 is a diagram showing a configurational example of an image processing system in the First Embodiment of the present disclosure.

FIG. 2 is a block diagram showing a configurational example of a 3D model data generating apparatus 101 in the First Embodiment.

FIG. 3 is a functional block diagram showing a configurational example of an image processing unit 203 in the First Embodiment.

FIG. 4 is a functional block diagram showing a configurational example of a 3D model image display apparatus 102 in the First Embodiment.

FIG. 5 is a flowchart showing a processing example of the 3D model data generating apparatus 100 in the First Embodiment.

FIG. 6 is a schematic diagram showing an example of an image capturing state for an image in the First Embodiment.

FIG. 7 is a schematic diagram showing an example of a captured image the First Embodiment.

FIG. 8 is a flowchart showing a processing example for the 3D model image display apparatus 102 in the First Embodiment.

FIG. 9 is a functional block diagram showing a configurational example of the image processing unit 203 of the 3D data model generating apparatus 101 in a Second Embodiment.

### DESCRIPTION OF THE EMBODIMENTS

Hereinafter, with reference to the accompanying drawings, favorable modes of the present disclosure will be described using Embodiments. In each diagram, the same reference signs are applied to the same members or elements, and duplicate descriptions will be omitted or simplified.

### First Embodiment

In the 3-dimensional image processing system of the First Embodiment of the present disclosure, the images for use in 3D modelling, and the reference image such as the image for use in the reference point of view, which becomes the reference for the virtual point of view at the time of the rendering of the 3D model, and the like, are images that are captured by the user. In addition, the virtual viewpoint for the 3D model image is determined based on the image capturing viewpoint from when the reference image such as the image for use in the reference viewpoint and the like was image captured.

Note that in the present embodiment, the images for use in the 3D model indicate images for generating the 3D model data (3-dimensional image). In addition, the 3D model data is information consisting of 3-dimensional information for the subject and texture information for the surfaces, and the 3D model image is made to indicate an image in which the 3D model data has been rendered as a 3-dimensional image based on the virtual viewpoint that has been set.

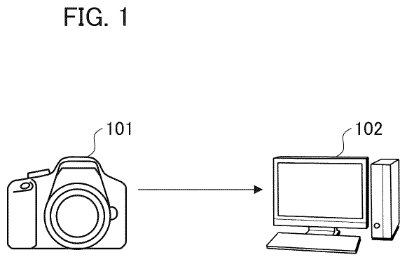

FIG. 1 is a diagram showing a configurational example of the 3-dimensional image processing system in the First Embodiment of the present disclosure. In FIG. 1, 101 is a 3D model data generating apparatus (for example, a camera) that captures images of a plurality of viewpoints for generating 3D model data, and generates the 3D model data.

102 is a 3D model image display apparatus for rendering the 3D model data that has been generated, generating and displaying a 3D model image, and allowing the user to view this.

As is shown in FIG. 1, the 3-dimensional image processing system of the present embodiment has the 3D model data generating apparatus 101 that serves as a 3-dimensional image generating apparatus, and the 3D model image display apparatus that serves as an external image display apparatus.

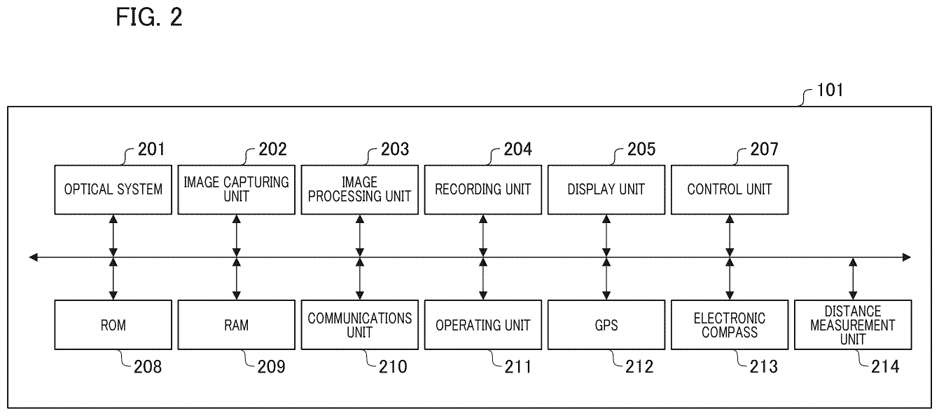

FIG. 2 is a block diagram showing a configurational example of the 3D model data generating apparatus 101 in the First Embodiment. In FIG. 2, the optical system 201 is configured by a lens group that includes a zoom lens and a focus lens, and forms subject images on the image capturing surface of the image capturing unit 202.

The image capturing unit 202 is an image capturing element such as, for example, a CCD, a CMOS sensor, and the like, and photoelectrically converts optical images that have been formed on the image capturing surface of the image capturing unit 202 by the image capturing optical system 201. An analogue image signal that has been obtained by photoelectric conversion is output as RAW image data after having been converted into digital image data by using an A/D conversion unit, which is not shown. The RAW image data that has been output from the image capturing unit 202 is temporarily stored in a RAM 209.

The image processing unit 203 performs development processing on the RA image data that is stored on the RAM 209, and generation processing for the 3D model data (3-dimensional images). Note that the image processing unit 203 functions as a 3-dimensional image generating unit configured to generate a 3-dimensional image of a subject based on a plurality of images. A configurational example of the image processing unit 203 and a detailed example of the processing contents thereof will be explained below.

A recording unit 204 is, for example, a detachable memory card, and the like. The recording unit 204 records, via the RAM 209, the 3D model data that has been generated by the image processing unit 203, and the information for the reference viewpoint, which will be described later.

A display unit 205 is a display device such as an LCD and the like, and performs display of images that are stored on the RAM 209 as well as live view images at the time of image capturing, the display of an operational user interface for receiving commands from the user, and the like.

A control unit 207 includes, for example, a CPU that serves as a computer, and reads out control programs for each block that the 3D model data generating apparatus 101 is provided with from a ROM 208, then expands and executes these on the RAM 209. The control unit 207 thereby controls the operations for each block that the 3D model data generating apparats 101 is provided with.

The ROM 208 is a nonvolatile memory that can be electronically deleted and recorded, and stores the necessary parameters for operating each block, and the like in addition to operation programs for each block that the 3D model data generating apparatus 101 is provided with.

The RAM 209 is a re-writable volatile memory, and is used for the expansion of programs that are executed by the control unit 207 and the like, and as a temporary storage and the like for data that has been generated by operations of each block that the 3D model data generating apparatus 101 is provided with, and the like.

210 is a communications unit that performs communications with the 3D model image display apparatus 102, and the like, which serves as an external image display unit, via a network that is not shown. Note that the communications unit 210 functions as a transmissions unit configured to transmit 3-dimensional images, to which information relating to a reference image has been added, to the image display apparatus.

An operating unit 211 is a touch panel, an operating button, and the like, and inputs commands from the user. In addition, the operating unit 211 is provided with a shutter button that is not shown, and the user is able to give commands when performing image capturing by SW1 (an operation of half pushing down the shutter button), and SW2 (an operation of fully pressing down the shutter button).

A GPS 212 is a GPS sensor that receives a GPS signal from a GPS satellite, and acquires positional information for the 3D model data generating apparatus 101. An electronic compass 213 is a magnetic sensor that detects geomagnetism, and acquires information for the image capturing direction (image capturing posture) of the 3D model data generating apparatus 101.

A distance measuring unit 214 is a distance measuring unit configured to measure a distance from the 3D model data generating apparatus 101 for each subject region that becomes a target, and for example, calculates the distance until a subject region using a phase difference that has been detected by a phase difference detection method focus detection unit, and position information for the image capturing lens.

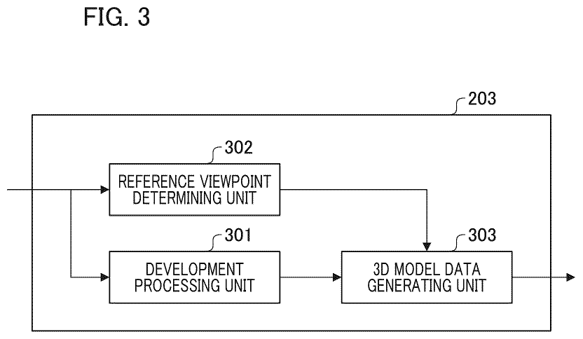

FIG. 3 is a functional block diagram showing a configurational example of an image processing unit 203 in the First Embodiment. Note that a portion of the functional blocks that are shown in FIG. 3 are realized by the CPU and the like that serves as a computer and is included in the control unit 207 of the 3D model data generating apparatus 101 executing a computer program that has been stored on the memory that serves as a storage medium.

However, a portion or the entirety of the blocks may also be made so as to be realized by hardware. As the hardware, an application-specific integrated circuit (ASIC), a processor, a reconfigurable processor, a DSP), and the like can be used.

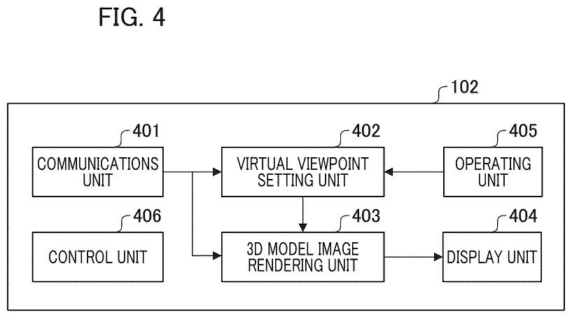

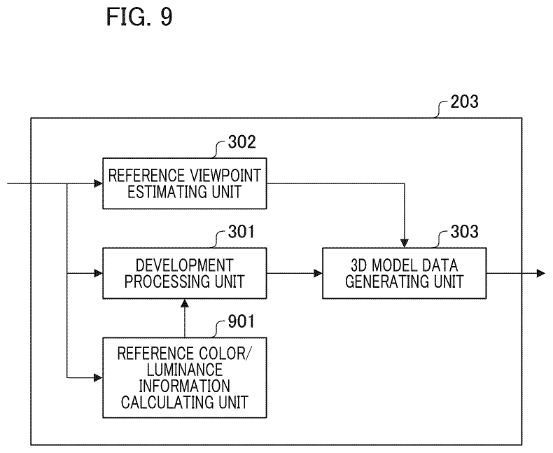

In addition, each functional block that is shown in FIG. 3 does not need be housed in the same body, and may also be configured by separate apparatuses that have been connected to each other via signal path. Note that the above explanation in relation to FIG. 3 also applies to FIG. 4, and FIG. 9 in the same manner.

In FIGS. 3, 301 is a development processing unit configured to generate images for use in the 3D model in order to generate 3D model data by performing development processing such as white balance adjustment, color interpolation, gamma processing, NR processing, and the like on the RAW image data that is stored in the RAM 209.

302 is a reference viewpoint determining unit configured to determine a viewpoint position that will become a reference based on the image for use in the reference viewpoint that has been image captured in order to make the reference for the virtual viewpoint when the 3D model data is being rendered. Note that the reference viewpoint determining unit 302 functions as a reference image determining unit in which the user determines the reference image that will become a reference for the display format for when displaying the 3-dimensional image on the external image display apparatus. In addition, in the present embodiment, the above-described display format includes the virtual viewpoint for when the 3-dimensional image is being displayed.

303 is a 3D model data generating unit that generates 3D model data based on the images for use in the 3D model that have been developed in the development processing unit 301. Note that the details of the processing for determining the reference viewpoint and the processing for generating the 3D model data will be explained below.

FIG. 4 is a functional block diagram showing a configurational example of the 3D model image display apparatus 102 in the First Embodiment. In FIGS. 4, 401 is a communications unit that performs communications with external devices via a network that is not shown, and, for example, acquires information for the 3D model data and reference viewpoint from the 3D model data generating apparatus 101.

In this context, the communications unit 401 functions as a receiving unit configured to receive, from the 3-dimensional image generating apparatus, the 3-dimensional image to which information has been added that relates to the reference image that will become the reference for the display format when the 3-dimensional image is displayed. Note that the communications unit 401 may also be configured to perform communications with an external device via a detachable memory card, and the like.

402 is a virtual viewpoint setting unit that sets a virtual viewpoint for when the 3D model data is rendered and displayed. 403 is a 3D model image rendering unit that renders 3D model data based on the viewpoint that has been set by the virtual viewpoint setting unit 402, and converts this to the 3D model image in a format that can be displayed on a display unit 404.

404 is a display unit that is a display device such as an LCD, an HMD, and the like for displaying the 3D model images that have been rendered. 405 is an operating unit, which is a user interface for receiving commands from the user, and receives operations from the user relating to the display of the 3D model image, and operations from the user relating to settings for the virtual viewpoint for when the 3D model image will be displayed.

For example, the user is able to indicate the position and direction for the virtual viewpoint for when the 3D model image is displayed by operating the operating unit 405 while viewing the 3D model image that is being displayed in the display unit 404.

In addition, in a case in which the display unit 404 is a head mounted display, it may also be made such that the direction in which the head mounted display is facing is detected, and this is made the direction of the viewpoint for when displaying the 3D model image.

406 is a control unit that includes a CPU serving as a computer, and executes control programs for each block of the 3D model image display apparatus 102, and controls the operations of each block.

Note that the 3D model image display apparatus 102 according to the present embodiment, which serves as an image display apparatus, receives, from a receiving unit, the 3-dimensional image to which information relating to the reference image has been added and displays the 3-dimensional image in a display format that is based on the information relating to the reference image.

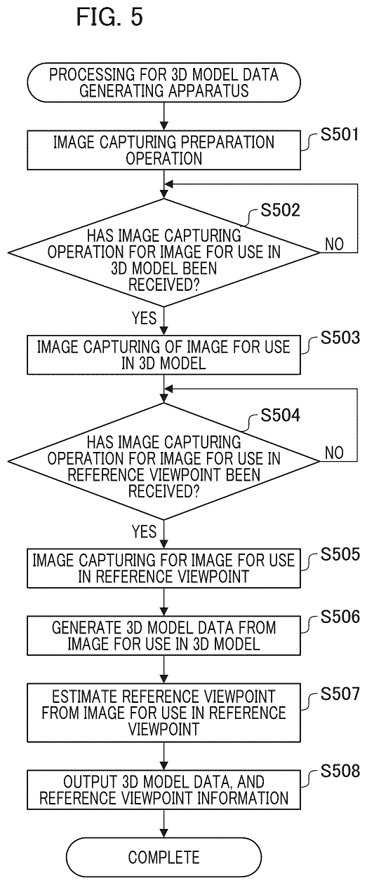

FIG. 5 is a flowchart showing a processing example for a 3D model data generating apparatus 101 in the First Embodiment. Note that the operations for each step of the flowchart in FIG. 5 are performed in order by the CPU and the like that serves as a computer inside of the control unit 207 executing the computer program that has been stored on the memory.

During step S501, the 3D model data generating apparatus 101 performs image capturing preparation operation. That is, the control unit 207 performs analysis of the current image capturing scene, determines the image capturing conditions such as the aperture, the shutter speed, the ISO sensitivity, the white balance, and the like, and controls the operations of each block of the 3D model data generating apparatus 101. When the image capturing preparation operation is completed, a live view image is displayed on the display unit 205, and it becomes a state in which operations can be received from the user.

During step S502, the control unit 207 determines whether or not an image capturing operation for the images for use in the 3D model has been received from the user. In a case in which Yes has been determined, the processing proceeds to step S503, and in a case in which No has been determined, standby is performed by continuously executing the determination for step S502.

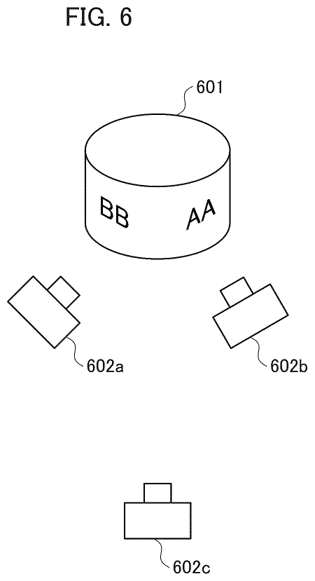

During step S503, the image capturing operation for the images for use in the 3D model is performed according to the user operations. In this context, a summary of the image capturing process will be explained by using the schematic diagram that is shown in FIG. 6.

FIG. 6 is a schematic diagram showing an example of a state of the image capturing for an image in the First Embodiment. In FIG. 6, 601 is a subject that will become the target of the 3D model data generation, and each of 602a, 602b, and 602c are examples of image capturing positions for the 3D model data generating apparatus 101.

The 3D model data generating apparatus 101 performs a display on the display unit 205 that prompts a user to perform image capturing while changing the image capturing position and image capturing direction in relation to the subject that will become the target. The user performs image capturing of the images by pushing down the shutter button, which is not shown, of the operating unit 211 while changing the image capturing position and image capturing direction in relation to the target subject as is shown for 602a, and 602b, while looking at the messages for image capturing commands, and the live view image that have been displayed on the display unit 205.

When image capturing is performed, the RAW image data that has been output from the image capturing unit 202 is temporarily recorded on the RAM 209 and the recording unit 204. Note that the image capturing operation in this context may also be made so as to be executed automatically by the control unit 207 in cases in which a subject that will become a target has been detected in the live view image during image capturing standby, and cases in which changes to the position and direction of the 3D model data generating apparatus 101 have been detected by the electronic compass 213.

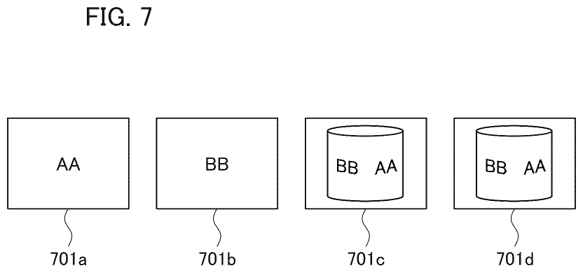

FIG. 7 is a schematic diagram showing an example of a captured image the First Embodiment. In FIG. 7, 701a, and 701b are image capturing examples for the images for use in the 3D model, and 701a is an image that has been captured from the position of 602a, and 701b is an image that has been captured from the position of 602b.

As has been explained above, the subject that will become a target is image captured from different viewpoints. In this context, during the image capturing of the images for use in the 3D model, image capturing is performed with the goal of clearly recording the 3-dimensional shape and the textures of the surface of the subject that will become the target. Therefore, the images that are captured during step S503 are not limited to images that have been captured in an image capturing position and an image capturing position that are suitable for being displayed as the 3D model image on the display device and being viewed.

During step S503, the control unit 207 determines whether or not the entire target subject region has been image captured as the images for use in the 3D model based on the image data that has been image captured and the detection results for the direction by the electronic compass 213. In a case in which it has been determined that the image capturing was sufficient, the image capturing operation for the images for use in the 3D model is completed, the processing proceeds to step S504, and after having switched to an image capturing mode in which image capturing is performed for the image for use in the reference viewpoint, the processing waits for a command from the user.

During step S504, the control unit 207 determines whether or not an image capturing operation for the image for use in the reference viewpoint has been received from the user. In a case in which Yes has been determined, the processing proceeds to step S505, and in a case in which No has been determined, standby is performed by repeatedly executing the determination for step S504.

During step S505, the image capturing operation for the image for use in the reference viewpoint is performed according to the user operation. The user changes the position and direction of the 3D model data generating apparatus 101 and performs image capturing in a desirable image capturing position and image capturing direction that is suitable for when the 3D model image will be displayed while confirming the live view image that is being displayed on the display unit 205.

In this context, the example of the image that has been image captured is shown as 701c in FIG. 7. 701c is different than the captured images 701a, and 701b, which are images for use in the 3D model image, and is an image that was image captured in the image capturing position and image capturing direction that the user would like to be displayed when the image is displayed and viewed.

When the image capturing is performed during step S505, the RAW image data that has been output from the image capturing unit 202 is temporarily recorded on the RAM 209 and the recording unit 204.

At this time, when the image capturing for the image for use in the reference viewpoint has been executed, the positional information for the 3D model data generating apparatus 101, the information for the image capturing direction that is indicated by the electronic compass 213, the information for the image capturing distance in relation to the target subject that has been measured by the distance measurement unit 214, and the like are added to the above described RAW images and stored. Note that each type of information that is described above is added to the images as, for example, metadata.

During step S506, the image processing unit 203 performs the generation the 3D model data based on the images for use in the 3D model. Specifically, the image processing unit 203 captures images during step S503, reads out, in order, the RAW image data that has been recorded, and performs development processing in the development processing unit 301.

Next, in the 3D model data generating unit 303, a well-known technology referred to as photogrammetry is used, and the 3D model data is generated from the captured images. Specifically, the following processing is performed. First, a foreground region and a background region are separated from the captured images, and 3-dimensional coordinates in a 3-dimensional space and a normal vector are calculated for each point of the foreground region, which is the target of the 3D model generation, and the 3D model data is constructed.

It is sufficient if the calculation of the 3-dimensional coordinates and the normal vector are performed based on the distance information that has been measured by the distance measurement unit 214. After this, the 3D model data that has been generated is segmented into partial regions, regions that correspond to the images for use in the 3D model are extracted for each partial region, and the 3D model data is generated by performing mapping.

During step S507, the image processing unit 203 estimates a reference viewpoint for when the 3D model image will be displayed based on the image for use in the reference viewpoint that has been image captured. In this context, the reference viewpoint represents the position that will become the reference for the virtual viewpoint for when the 3D model data that was generated during step S506 is rendered in order to be displayed on the display device.

Specifically, the operations described below are performed. First, the image processing unit 203 reads out the RAW image data that is recorded on the RAM 209 and the recording unit 204, and the information that has been added to the RAW image data and recorded.

Next, the reference viewpoint determining unit 302 estimates the virtual viewpoint position from the information from the time of the image capturing of the image for use in the reference viewpoint such as the time of the image capturing of the image for use in the reference viewpoint based on the position of the 3D model data generating apparatus, the image capturing direction, the image capturing angle of view, the subject distance, and the like, which is information that has been additionally recorded. That is, in the present embodiment, the virtual viewpoint is estimated based on at least one of the position of the image capturing apparatus, the image capturing direction, the image capturing angle of view, and the subject distance in relation to the subject for when the reference image was image captured.

Furthermore, the reference viewpoint determining unit 302 associates the viewpoint position from the time of the image capturing, which has been estimated, with the three dimensional coordinates for the 3D model data that was generated during step S506, and determines this position as the reference viewpoint. It thereby becomes such that the viewpoints in relation to the target subject match in the image from when the 3D model data was rendered based on the reference viewpoint and in the images for use in the reference viewpoint.

During step S508, the image processing unit 203 outputs the 3D model da that has been generated and the information for the reference viewpoint and records these in the recording unit 204.

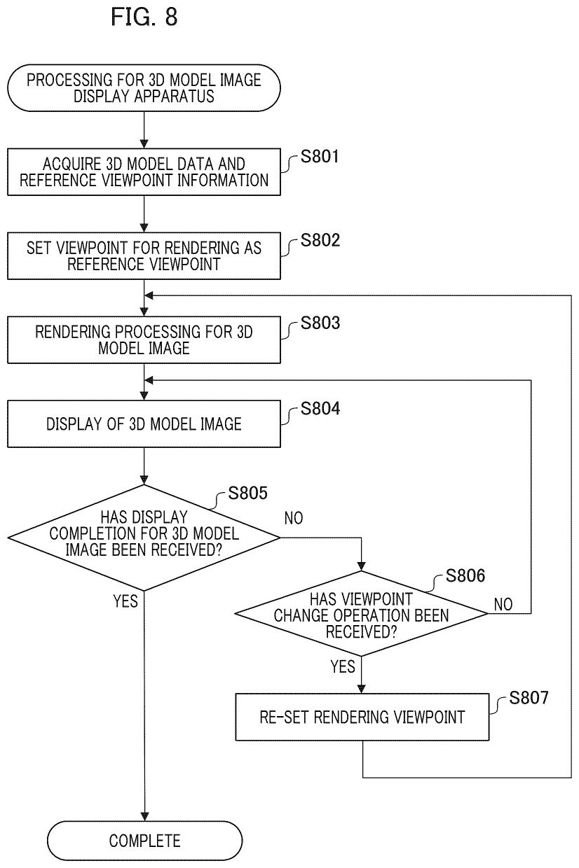

FIG. 8 is a flowchart showing an example of processing for the 3D model image display apparatus 102 in the First Embodiment. Note that the operations for each step of the flowchart in FIG. 8 are performed in order by the CPU and the like that serves as a computer inside of the control unit 406 of the 3D model image display apparatus 102 executing a computer program that has been stored on a memory.

During step S801, the communications unit 401 of the 3D model image display apparatus 102 receives and acquires the 3D model image that has been generated by the 3D model data generating apparatus 101 and the information for the reference viewpoint. In this context, the communications may be communications that are performed with the communications unit 210 of the 3D model data generating apparatus 101 via a network that is not shown, and the communications may also be made so as to perform data communications via a recording medium that has been recorded on the recording unit 204 of the 3D model data generating apparatus 101.

During step 802, the virtual viewpoint setting unit 402 sets the reference viewpoint that has been received as the virtual viewpoint for when rendering the 3D model data.

During step S803, the 3D model image rendering unit 403 performs rendering on the 3D model data that has been received such that this becomes image data in a format that is suitable for being displayed on the display unit 404.

An example of a 3D model image for which rendering has been performed is shown by 701d in FIG. 7. During step S802, the virtual viewpoint for the time of the rendering is set so as to become the reference viewpoint, and therefore, the viewpoint in the image for use in the reference viewpoint shown in 701c, and the viewpoint in the 3D model image from the time of rendering shown in 701d match.

That is, the image display apparatus according to the present embodiment controls the display format such that the display format for when the reference image is displayed and the display format for when the 3-dimensional image is displayed match. It thereby becomes possible to generate and display 3D model images as seen from the desired viewpoint of the user.

During step S804, the 3D model image rendering unit 403 outputs and displays the image that has been rendered to the display unit 404.

During step S805, the control unit 406 determines whether or not an operation has been received for completing the display of the 3D model image from the user. In a case in which this operation has been received, the processing flow shown in FIG. 8 is completed. In a case in which this operation has not been received, the processing proceeds to step S80.

During step 806, the control unit 406 determines whether or not an operation has been received from the user to change the viewpoint of the 3D model image display on the display unit 404. In a case in which this operation has been received, the processing proceeds to step S807, and in a case in which this operation has not been received, the processing proceeds to step S804, and the display of the 3D model image is continued.

During step S807, the viewpoint for the rendering is set again. That is, virtual viewpoint setting unit 402 sets the information for the viewpoint that was set by the viewpoint change operation during step S806 by the user as the virtual viewpoint for the time of the rendering in the 3D model image rendering unit 403.

When setting the new viewpoint has been completed, the processing proceeds to step S803, and the 3D model image rendering unit 403 performs rendering of the 3D model image. The viewpoint for the 3D model image that is displayed on the display unit 404 is thereby changed according to a user command.

As has been explained above, according to the First Embodiment of the present disclosure, it has been made such the viewpoint for the time of image capturing of the image for use in the reference viewpoint that was image captured by the user is set as the initial position for the virtual viewpoint for when the 3D model image is rendered.

It thereby becomes possible for the user to perform settings such that the viewpoint in the display of the 3D model image becomes as planned by just capturing images from an image capturing position in which the appearance of the target subject becomes a desired state.

Note that in the above described example, although an explanation has been given of an example in which the image capturing of the images and the generation of the 3D model data is performed in the 3D model data generating apparatus 101, the configuration of the 3D model data generating apparatus is not limited thereto.

For example, this may also be a configuration in which an image capturing apparatus that performs image capturing for the images and an apparatus that performs the generation of the 3D model data are separate. In addition, this may also be a configuration in which the apparatus that performs the generation of the 3D model data and the display apparatus that performs the display of the 3D model image are included in the same apparatus.

In addition, in the present embodiment, although an example has been explained in which the information for the reference viewpoint that has been set by the user is used as the initial viewpoint for when the images are rendered, the usage of the information for the reference viewpoint is not limited thereto. For example, it may also be made such that when the 3D model image is being displayed, the information for the reference viewpoint is displayed as information for a recommended viewpoint, and the user is able to select and determine the viewpoint.

In addition, although an example has been explained in which in the present embodiment, the image capturing of the images for use in the 3D model and the image capturing for the image for use in the reference viewpoint are performed individually, the generation method for the image for use in the reference viewpoint is not limited thereto. For example, it may also be made such that the user selects one desired image from among the images for use in the 3D model, and the image that has been selected is used as the image for use in the reference viewpoint.

In addition, in the present embodiment, an explanation has been given of case in which the image capturing for the images for use in the 3D model and the image capturing for the image for use in the reference viewpoint are performed using the same image capturing apparatus. That is, an explanation has been given of an example in which the plurality of images that are used for generating the 3D image and the reference image are images that have been captured by the same image capturing apparatus.

However, the generation method for the image for use in the reference viewpoint is not limited thereto. For example, a subject that is the same as or similar to the target subject for the 3D model image may be image captured using a different image capturing apparatus, and the image that has been captured using this other image capturing apparatus may also be used as the image for use in the reference viewpoint.

That is, the plurality of images that are used in order to generate the 3-dimensional image and the reference image may also be images that have been captured by different image capturing apparatuses. In this case, it is sufficient if the estimation method for the reference viewpoint is performed in the manner described below.

First, a plurality of 3D model images that have been rendered from different viewpoints than each other are generated, and feature points are extracted for each of the different 3D model images. In the same manner, a feature point extraction is also performed for the image for use in the reference viewpoint that was image captured by the separate image capturing apparatus described above.

In this context, it is sufficient if it is determined that the 3D model image with the highest degree of correspondence for the feature points has been rendered based on a viewpoint that is close to the image for use in the virtual viewpoint when feature point matching has been performed between each of the plurality of 3D model images and the above described image for use in the reference viewpoint.

In addition, although in the present embodiment, a case in which only one image for use in the reference viewpoint has been image captured has been explained, the contents of the image for use in the reference viewpoint is not limited to this. A plurality of images for use in the reference viewpoint may also be captured from different viewpoints, and the reference viewpoint may be estimated from these images.

In this case, the plurality of reference viewpoints that have been estimated may also be displayed on a GUI as a plurality of recommended viewpoints so as to be selectable by the user when the 3D model images are rendered and displayed. In addition, control may also be performed such that there are movements in the image that is displayed by rendering and displaying the image while temporally changing the viewpoint when for when the 3D model image is rendered.

### Second Embodiment

Below, the Second Embodiment of the present disclosure will be explained. In the First Embodiment, an example was explained in which the viewpoint for when the 3D model image is rendered was controlled based on the viewpoint from the time of image capturing for the image for use in the reference viewpoint.

In relation to this, in the Second Embodiment, an example will be explained in which an image for use in a reference color/luminance that will become a reference for at least one of the color and the brightness when displaying the target subject, and the generation of the 3D model image is controlled. Note that in the present embodiment, the image for use in the reference color/luminance is acquired as the reference image.

FIG. 9 is functional block diagram showing a configurational example of the image processing unit 203 of the 3D model data generating apparatus 101 in the Second Embodiment. In FIG. 9, the same reference numerals will be attached to the configurations that are the same as configurations in the First Embodiment that were shown in FIG. 3, and detailed explanations thereof will be omitted. In FIG. 9, a reference color/luminance information detecting unit 901 has been added, wherein the reference color/luminance information is information for the color and brightness of the target subject in the image for use in the reference color/luminance.

The generation processing flow for the 3D model data in the Second Embodiment is the same as the processing flow for the First Embodiment that was shown in FIG. 5. However, new processing is added in relation to the development processing for the RAW data for use for the 3D model image in step S506.

That is, for example, after step S505, an image capturing step for the image for use in the reference color/luminance for performing image capturing of the image for use in the reference color/luminance is further inserted. In this case, in the same manner as the image for use in the reference viewpoint in the First Embodiment, the image for use in the reference color/luminance is generated using an image that has been captured by the user setting the 3D model data generating apparatus 101 such that the captured image becomes the desired color and brightness.

Next, during step S506, processing is performed in which a setting value for the development processing for the images for use in the 3D model, which is performed by the development processing unit 301, is determined based on the color and brightness of the target subject in the image for use in the reference color/luminance.

In this context, during the image capturing for the images for use in the model, in order to correctly record the features such as the shape and texture of the subject, it is preferable that image capturing is performed in a standard exposure state. However, in a case in which the intensity difference for the target subject is large, in order to prevent overexposure of the bright portions, it is preferable that the image capturing is performed in a darker than average exposure state. In contrast, it is preferable that the brightness of the image for when the 3D model image is being displayed and viewed on the 3D model image display unit 102 is a brightness that reflects the image capturing plan of the user.

Therefore, in the present embodiment, for example, the color and brightness that are desired by the user when displaying the target subject are estimated from the image capturing parameters and development parameters that were set by the user when the image for use in the reference color/luminance was image captured after step S505. In addition, the development parameters during the development processing for the images for use in the 3D model are set based on the color and brightness that have been estimated.

In addition, the reference color/illuminance information calculating unit 901 reads out, from the recording unit 204, the image capturing parameters and the development parameters that were set during the image capturing of the image for use in the reference color/luminance and the image capturing of the images for use in the 3D model prior to the development processing for images for use in the 3D model.

In this context, the image capturing parameters and the development parameters are made parameters that have been recorded by being added to each piece of RAW image data that was captured. In addition, the image capturing parameters include at least one of the aperture the shutter speed, the IOS sensitivity, the exposure correction amount, white balance settings, and the like, which determine the exposure state. In addition, the exposure parameters include at least one of the characteristic information for the gamma curve, the color correction amount, the color temperature correction, and the like, which determine the color and luminance, during the development processing.

Next, the reference color/luminance information detecting unit 901 performs a comparison of the image capturing parameters and the development parameters corresponding to the image for use in the reference color/luminance that has been read out, and the images for use in the 3D model. For example, if the ISO sensitivity at the time of image capturing of the image for use in the reference color/luminance was a value that is one grade higher than the ISO sensitivity from the time of the image capturing of the images for use in the 3D model, it is thought that the user intends for the 3D model image to be displayed and viewed in a state that is brighter than a normal exposure state.

Therefore, the reference color/luminance information detecting unit 901 determines a gain setting value for the brightness during the development processing in the development processing unit 301 such that this becomes one grade brighter than the normal development results. That is, the development parameters for the images for use in the 3D model are determined such that the color and luminance of the target subject in the images for use in the 3D model post development processing become close to the color and luminance of the target subject in the image for use in the reference color/luminance.

After this, the 3D model data generating unit 303 performs the generation processing for the 3D model data by using the images for use in the 3D model that have been developed. In this context, the contents of this generation processing are the same as those in the First Embodiment, which was explained above, and therefore, a detailed explanation thereof will be omitted.

As has been described above, according to the Second Embodiment, it has been made such that the development processing for the images for use in the 3D model is controlled based on the information for the color and brightness of the target subject in the image for use in the reference color/luminance, which has been image captured by the user.

It thereby becomes possible for the color and brightness in the display of the 3D model image to be set such they become a desired state by the user just capturing the image with settings in which the color and brightness of the target subject become the desired state.

Note that although in the above explanation, an example was explained in which the reference color/luminance information is estimated from the image capturing parameters and the development parameters from the time of the image capturing of the image for use in the reference color/luminance, the calculation method for the reference color/luminance information is not limited thereto. For example, it may also be made such that values for the color phase, color saturation, and luminance for the target subject are calculated from the image for use in the reference color/luminance post development processing, and this information is used as the reference color/luminance information.

In addition, although an example has been explained of a case in which the development parameters for the images for use in the 3D model are determined based on the reference color/luminance information, the usage of the reference color/luminance information is not limited thereto. For example, it may also be made such that the values for the colors and luminance of the target subject in the images for use in the 3D model post development processing are calculated, and conversion processing is performed for the colors and luminance such that these values become close to the values for the colors and luminance of the target subject in the image for use in the reference color/luminance.

In addition, it may also be made such that after the 3D model data has been generated from the images that have been captured, conversion processing for the colors and luminance is performed on the texture image data that configures the 3D model data. In addition, it may also be made such that the reference color/luminance information is added to the 3D model data and recorded, and conversion processing for the colors and luminance is performed when the rendering is performed to match the display device in the 3D model display apparatus.

That is, any method may be used as long as it is a method that performs control such that the colors and luminance of the target subject for when the 3D model image is displayed on the display device in the 3D model image display apparatus 102 match the color and luminance of the target subject in the image for use in the reference color/luminance.

In addition, it may also be made such that when developing the images for use in the 3D model, the image data that is used in the generation processing for the 3D model data and the image data that is mapped as the texture image in the 3D model data that has been generated are developed using different settings.

In this case, development processing is performed using standard development parameters such that this is suitable for the necessary processing for 3D model data generation such as feature point extraction, and the like in the image data that is used in the 3D model data generation processing. In addition, it is sufficient if it is made such that development processing is performed using development parameters that were set based on the reference-use color/luminance information in the image data that is used as the texture images for mapping.

By doing so, it becomes possible to convert the colors and luminance of 3D model image to the desired state of the user without affecting the precision of the 3D model data generation processing.

In addition, although in the present embodiment, an explanation has been given of a case in which the state for when the 3D model image is displayed is controlled using information for at least one of the color and luminance of the target subject image in the image for use in the reference color/luminance, the contents of the control for the 3D model image are not limited thereto.

For example, it may also be made such that the information for the depth of field in the reference image such as the image for use in the reference color/luminance and the like is used. For example, a case is considered in which a foreground region, which is the target subject, and a background region are included in both the reference image such as the image for use in the reference color/luminance and the like, and the 3D model image.

In this case, it may also be made such that blurring processing is applied to the 3D model image such that the degree of blurring of the foreground and the background in the 3D model image becomes close to the degree of blurring in the foreground and background in the reference image such as the image for use in the reference color/luminance and the like.

In addition, illumination characteristics such as the color, position and brightness of the environmental light that is illuminating the subject when the reference image such as the image for use in the reference color/luminance and the like is image captured may be estimated, and this may be used as a reference for when deciding the illumination characteristics such as the color, position, and brightness, and the like of the virtual environmental light for when the 3D model image is rendered.

In addition, it may also be made such that the generation of the 3D model image is controlled based on information for a region of the target subject that is included in the reference image such as the image for use in the reference color/luminance and the like. For example, the timing of the image capturing of the images for use in the 3D model and the generation processing for the 3D model data may also be controlled such that a subject region that is included in the reference image such as the image for use in the reference color/luminance and the like, and a region that is near the center of the reference image become 3D model data with a higher definition than other regions.

In addition, the range of the subject region that has been image captured the reference image such as the image for use in the reference color/luminance and the like, and the information for the image such as the ratio in the image that is taken up by the subject region may also be used in the control of the display of the 3D model image. That is, it may also be made such that scaling processing and trimming processing are performed on the 3D model image that has been generated such that the reference image such as the image for use in the reference color/luminance and the like and the 3D model image that has been rendered have the same angle of view.

In this manner, in the above-described embodiments, the display format for the 3-dimensional image includes at least one of the color, brightness, depth of field, illumination characteristics, the resolution for each partial region of the 3-dimensional image, and the like for when the 3-dimensional image is displayed.

Note that although in the above explanation, an explanation is given of an example in which the image for use in the reference viewpoint, the image for use in the reference color/luminance, and the like are image captured separately, the image for use in the reference viewpoint, the image for use in the reference color/luminance, and the like may also both be generated from a reference image that was obtained from performing image capturing once.

In addition, although in the above explanation, an explanation has been given of an example in which the image for use in the reference viewpoint, the image for use in the reference color/luminance, and the like are acquired, it may also be made such that at least one of the image for use in the reference viewpoint, the image for use in the reference color/luminance, and the like is generated as a reference image, and the generation for the 3D model image is controlled using this.

While the present disclosure has been described with reference to embodiments, it is to be understood that the disclosure is not limited to the disclosed embodiments. The scope of the following claims is to be accorded the broadest interpretation so as to encompass all such modifications and equivalent structures and functions.

In addition, as a part or the whole of the control according to the embodiments, a computer program realizing the function of the embodiments described above may be supplied to the 3-dimensional image processing system and the like through a network or various storage media. Then, a computer (or a CPU, an MPU, or the like) of the 3-dimensional image processing system and the like may be configured to read and execute the program. In such a case, the program and the storage medium storing the program configure the present disclosure.

In addition, the present disclosure includes those realized using at least one processor or circuit configured to perform functions of the embodiments explained above. For example, a plurality of processors may be used for distribution processing to perform functions of the embodiments explained above.

This application claims the benefit of Japanese Patent Application No. 2025-020363,filed on Feb. 10, 2025, which is hereby incorporated by reference herein in its entirety.

What is claimed is:

1. A 3-dimensional image processing system having a 3-dimensional image generating apparatus; and an image display apparatus;
wherein the 3-dimensional image generating apparatus comprises at least one processor; and a memory coupled to the at least one processor, the memory storing instructions that, when executed by the at least one processor, cause the at least one processor to:
generate a 3-dimensional image of a subject based on a plurality of images;
determine a reference image that will become a reference for a display format for when the 3-dimensional image is displayed on an external image display apparatus; and
transmit the 3-dimensional image, to which information relating to the reference image has been added, to the image display apparatus;
wherein the image display apparatus comprises at least one processor; and a memory coupled to the at least one processor, the memory storing instructions that, when executed by the at least one processor, cause the at least one processor to:
receive the 3-dimensional image to which the information relating to the reference image has been added, and display the 3-dimensional image in a display format based on the information relating to the reference image.

2. The 3-dimensional image processing system according to claim 1, wherein in the image display apparatus, the display format is controlled such that a display format for when the reference image is displayed matches the display format for when the 3-dimensional image is displayed.

3. The 3-dimensional image processing system according to claim 2, wherein the display format includes a virtual viewpoint for when the 3-dimensional image is displayed.

4. The 3-dimensional image processing system according to claim 3, wherein the virtual viewpoint is estimated based one at least one of a position, image capturing direction, image capturing angle of view, and subject distance for an image capturing apparatus in relation to a subject for when the reference image is being image captured.

5. The 3-dimensional image processing system according to claim 1, wherein the display format for the 3-dimensional image includes at least one of a color, brightness, subject depth, virtual illumination characteristic, and resolution for each partial region of a the 3-dimensional image for an image for when the 3-dimensional image is displayed.

6. The 3-dimensional image processing system according to claim 1, wherein the plurality of images that are used to generate the 3-dimensional image, and the reference image are images that were captured using the same image capturing apparatus.

7. The 3-dimensional image processing system according to claim 1, wherein the plurality of images that are used to generate the 3-dimensional image, and the reference image are images that were captured using different image capturing apparatuses.

8. A 3-dimensional image generating apparatus comprising:
at least one processor; and a memory coupled to the at least one processor, the memory storing instructions that, when executed by the at least one processor, cause the at least one processor to:
generate a 3-dimensional image of a subject based on a plurality of images;
determine a reference image that will become a reference for a display format for when the 3-dimensional image is displayed on an external image display apparatus; and
transmit the 3-dimensional image, to which information relating to the reference image has been added, to the image display apparatus.

9. An image display apparatus comprising:
at least one processor; and a memory coupled to the at least one processor, the memory storing instructions that, when executed by the at least one processor, cause the at least one processor to:
receive a 3-dimensional image, to which information relating to a reference image that will become a reference for a display format for when the 3-dimensional image is displayed has been added;
and display the 3-dimensional image in a display format based on the information relating to the reference image that has been received.

10. A 3-dimensional image generating method comprising:
generating a 3-dimensional image of a subject based on a plurality of images
determining a reference image that will become a reference for a display format for when the 3-dimensional image is displayed on an external image display apparatus; and
transmitting the 3-dimensional image, to which information relating to the reference image has been added, to the image display apparatus.

11. An image display method comprising:
receiving, from a 3-dimensional image generating apparatus, a 3-dimensional image to which information relating to a reference image that will become a reference for a display format for when the 3-dimensional image displayed has been added; and
displaying the 3-dimensional image in a display format based on the information relating to the reference image that has been received.

12. A non-transitory computer-readable storage medium configured to store a computer program for a 3-dimensional image generating apparatus to execute the following processes:
generating a 3-dimensional image of a subject based on a plurality of images
determining a reference image that will become a reference for a display format for when the 3-dimensional image is displayed on an external image display apparatus; and
transmitting the 3-dimensional image, to which information relating to the reference image has been added, to the image display apparatus.

13. A non-transitory computer-readable storage medium configured to store a computer program for an image display apparatus to execute the following processes:
receiving, from a 3-dimensional image generating apparatus, a 3-dimensional image to which information relating to a reference image that will become a reference for a display format for when the 3-dimensional image will be displayed has been added; and
displaying the 3-dimensional image in a display format based on the information relating to the reference image that has been received.
